(19) United States
(12) Patent Application Publication
(10) Pub. No.: US 2025/0306283 A1
(43) Pub. Date: Oct. 2, 2025

(54) SEPARATION FILTER AND QUANTUM COMMUNICATION SYSTEM USING THE SAME

(71) Applicant: UNIVERSITY OF SEOUL INDUSTRY COOPERATION FOUNDATION, Seoul (KR)

(72) Inventors: Juhan LEE, Seoul (KR); Taeho WOO, Seoul (KR); Kyungtaek LEE, Seoul (KR)

(73) Assignee: UNIVERSITY OF SEOUL INDUSTRY COOPERATION FOUNDATION, Seoul (KR)

(21) Appl. No.: 19/078,645

(22) Filed: Mar. 13, 2025

(30) Foreign Application Priority Data
Apr. 1, 2024 (KR) 10-2024-0043996

(51) Int. Cl. G02B 6/293; G02B 6/02; H04B 10/70

(52) U.S. Cl. CPC G02B 6/2932; G02B 6/02076; G02B 6/29361; G02B 6/29395; H04B 10/70

(57) ABSTRACT

There is provided a separation filter. The separation filter includes: an optical circulator including first to fourth ports; a first fiber Bragg grating connected to the second port, reflecting a wavelength component of a signal input through the first and second ports corresponding to a quantum signal to output toward the second port; a first angle-cleaved fiber having a first end and connected to the first fiber Bragg grating and a second end angle-cut; a second fiber Bragg grating connected to the third port and reflecting a wavelength component of a signal input through the second and third ports corresponding to the quantum signal to output toward the third port; and a second angle-cleaved fiber having a first end connected to the second fiber Bragg grating and a second end angle-cut, wherein the quantum signal input through the third port is output through the fourth port.

### CROSS-REFERENCE TO RELATED PATENT APPLICATION

This non-provisional U.S. patent application is based on and claims priority under 35 U.S.C. § 119 of Korean Patent Application No. 10-2024-0043996, filed on Apr. 1, 2024, in the Korean Intellectual Property Office, the entire contents of which are hereby incorporated by reference.

### BACKGROUND

### 1. Field

The present disclosure relates to a separation filter and a quantum communication system using the same.

The technique disclosed herein was supported by the National Research Foundation of Korea (NRF) grant funded by the Korea government (Ministry of Science and ICT (MSIT)) (Project name: “Anti-eavesdropping technology based on quantum cryptography for application to subscriber optical communication networks,” NIST No.: 1711196351, Project No.: 00242396), and also supported by Institute for Information & communications Technology Promotion (IITP) grant funded by the Korea government (Ministry of Science and ICT (MSIT)) (Project name: “Development of elemental technologies for Ultra-secure Quantum Internet,” NIST No.: 1711152525, Project No.: 2021-0-01810-002).

### 2. Related Art

Quantum cryptographic communication technology employs quantum key distribution (QKD) techniques, which are based on the principles of quantum physics, to distribute cryptographic keys in real time between a transmitter and a receiver. The quantum cryptographic communication technology is recognized as a next-generation communication security method in which eavesdropping or wiretapping is theoretically infeasible.

Furthermore, in order to enable the efficient and practical application of quantum key distribution over long distances, it is preferable to integrate conventional optical fiber communication technologies with the quantum key distribution techniques.

For example, optical networks, to which fiber-optic communication technology is used, employ wavelength-division multiplexing (WDM) optical communication channels (hereinafter also referred to as “optical channels”) for medium-to-long distance communications. Due to inherent transmission losses in the optical channels, optical amplifiers are used to amplify the signals of the optical channels (hereinafter also referred to as “optical signals”), and the amplified optical signals are transmitted. As a result, amplified spontaneous emission (ASE) noise, which is noise spontaneously emitted due to the amplification of the optical signals, may be generated. In addition, when the optical signals are propagated, spontaneous Raman scattering and four wave mixing can be induced.

For transmitting signals for the quantum key distribution (hereinafter also referred to as “quantum signals”) via a channel dedicated to transmitting the quantum signals (hereinafter also referred to as a “quantum channel”) among the WDM optical channels, at the transmitter of the optical communication system, the quantum signal is integrated with the optical signal, which is amplified by an optical amplifier, using WDM technology, and the integrated signal is subsequently transmitted to the receiver. In general, the quantum signal is an extremely weak signal, typically exhibiting a power level below −100 dBm.

At the receiver of the optical communication system, the WDM technology is utilized to separate and receive the optical signal and the quantum signal.

In a case where both the quantum signal and the amplified optical signal are transmitted and received via the WDM technology, the significant disparity in signal intensity between these two signals may result in interference from the optical signal with the quantum signal. Consequently, this interference can reduce a transmission distance of the quantum signal and increase a quantum bit error rate, which may cause the quantum signal to become so distorted that extraction of the quantum key becomes infeasible. In addition, noise due to amplifier ASE, the spontaneous Raman scattering, and the four wave mixing may degrade the quality of the quantum signal at a receiver end.

### SUMMARY

It is an object of the technique of the present disclosure to provide a separation filter and a quantum communication system using the separation filter, which are capable of efficiently separating a quantum signal from an amplified optical signal (particularly from noise components associated with the amplified optical signal), even when the quantum signal and the amplified optical signal are combined for transmission and reception using a wavelength-division multiplexing (WDM) technology, thereby reducing a quantum bit error rate and increasing a transmission distance of the quantum signal.

According to one aspect of the technique of the present disclosure, there is provided a separation filter including: an optical circulator including a first port, a second port, a third port, and a fourth port; a first fiber Bragg grating connected to the second port and configured to: reflect a wavelength component of a signal input through the first and second ports and including both a quantum signal and noise wherein the wavelength component corresponds to the quantum signal; and output the reflected wavelength component toward the second port; a first angle-cleaved fiber having a first end and a second end, the first end being connected to the first fiber Bragg grating and the second end being angle-cut to form a predetermined first angle; a second fiber Bragg grating connected to the third port and configured to: reflect a wavelength component of a signal input through the second and third ports wherein the wavelength component corresponds to the quantum signal; and output the reflected wavelength component toward the third port; and a second angle-cleaved fiber having a first end and a second end, the first end being connected to the second fiber Bragg grating and the second end being angle-cut to form a predetermined second angle. Further, the quantum signal input through the third port is output through the fourth port.

According to another aspect of the technique of the present disclosure, there is provided a separation filter including: an optical circulator including a first port, a second port, and a third port; a bidirectional bandpass filter connected to the second port of the optical circulator and configured to pass a wavelength component from a signal input through the first and second ports and including both a quantum signal and noise wherein the wavelength component corresponds to the quantum signal; a first fiber Bragg grating connected to the bidirectional bandpass filter and configured to: reflect a wavelength component of a signal received through the bidirectional bandpass filter wherein the wavelength component corresponds to the quantum signal; and output the reflected wavelength component through the bidirectional bandpass filter and the second port; and a first angle-cleaved fiber having a first end and a second end, the first end being connected to the first fiber Bragg grating and the second end being angle-cut to form a predetermined first angle. Further, the quantum signal input through the second port is output through the third port.

According to still another aspect of the technique of the present disclosure, there is provided a quantum communication system using one of the separation filters described above.

According to the embodiments of the present disclosure, it is possible to efficiently separate the quantum signal from the amplified optical signal (particularly from the noise components associated with the amplified optical signal), even when the quantum signal and the amplified optical signal are combined for transmission and reception using wavelength-division multiplexing (WDM) technology. As a result, the quantum bit error rate is reduced, and the transmission distance of the quantum signal is extended.

### BRIEF DESCRIPTION OF THE DRAWINGS

FIG. 1 is a schematic view illustrating an exemplary configuration of a separation filter according to a first embodiment of the technique of the present disclosure.

FIG. 2 is a schematic view illustrating an example in which a first fiber Bragg grating reflects a quantum signal while transmitting noise in the separation filter according to the first embodiment of the technique of the present disclosure.

FIG. 3 is an enlarged schematic view illustrating a first angle-cleaved fiber employed in the separation filter according to the first embodiment of the technique of the present disclosure.

FIG. 4 is an enlarged schematic view illustrating a second angle-cleaved fiber employed in the separation filter according to the first embodiment of the technique of the present disclosure.

FIG. 5 is an enlarged schematic view illustrating a refractive index matching material applied to the first angle-cleaved fiber in the separation filter according to the first embodiment of the technique of the present disclosure.

FIG. 6 is an enlarged schematic view illustrating a refractive index matching material applied to the second angle-cleaved fiber in the separation filter according to the first embodiment of the technique of the present disclosure.

FIG. 7 is a schematic view illustrating an exemplary configuration of a separation filter according to a second embodiment of the technique of the present disclosure.

FIG. 8 is a schematic view illustrating an example in which the separation filter 1000 or the separation filter 1000′ according to the technique of the present disclosure is employed in the quantum communication system.

### DETAILED DESCRIPTION

Hereinafter, one or more embodiments (also simply referred to as “embodiments”) of a separation filter and a quantum communication system according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

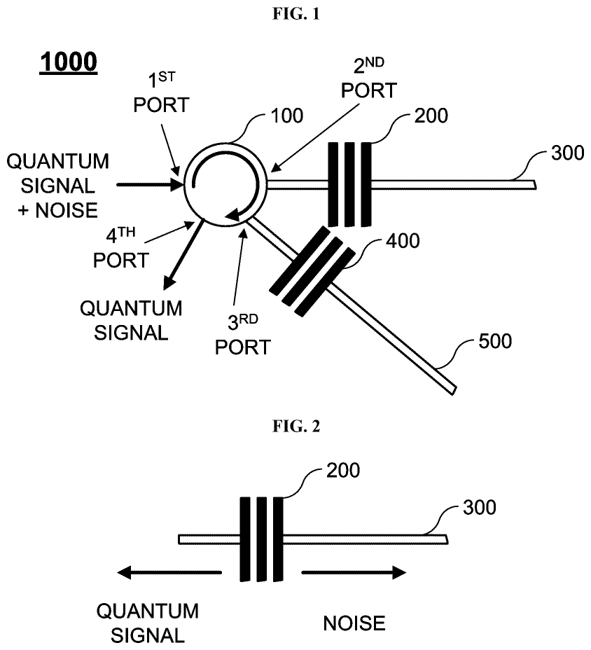

FIG. 1 is a schematic view illustrating an exemplary configuration of a separation filter 1000 according to a first embodiment of the technique of the present disclosure.

As shown in FIG. 1, the separation filter 1000 according to the first embodiment includes, for example, an optical circulator 100, a first fiber Bragg grating 200, a first angle-cleaved fiber 300, a second fiber Bragg grating 400, and a second angle-cleaved fiber 500.

In one example, the optical circulator 100 may be a four-port optical circulator including a first port, a second port, a third port, and a fourth port.

In the optical circulator 100, a signal entering via the first port may be output through the second port; a signal entering via the second port may be output through the third port; a signal entering via the third port may be output through the fourth port; and a signal entering via the fourth port may be output through the first port.

In the first embodiment, a quantum signal along with noise (specifically, noise generated by the amplification of the optical signal) may be input to the first port and may be routed to the second port for output.

In the first embodiment, the first fiber Bragg grating 200 may be connected to the second port of the optical circulator 100. The first fiber Bragg grating 200 may be configured to selectively reflect the wavelength component corresponding to the quantum signal from an input signal, which includes the quantum signal and noise and is received through the first and second ports of the optical circulator 100, and to route the reflected wavelength component (the quantum signal) toward the second port of the optical circulator 100 for output.

FIG. 2 is a schematic view illustrating an example in which the first fiber Bragg grating 200 reflects the quantum signal while transmitting the noise in the separation filter 1000 according to the first embodiment of the technique of the present disclosure.

As shown in FIG. 2, the quantum signal is reflected by the first fiber Bragg grating 200 toward the second port of the optical circulator 100, while the noise passes through the first fiber Bragg grating 200 and is transmitted through the first angle-cleaved fiber 300.

In the first embodiment, the first angle-cleaved fiber 300 may include a first end and a second end. The first end may be connected to the first fiber Bragg grating 200, while the second end may be angle-cut to form a predetermined first angle.

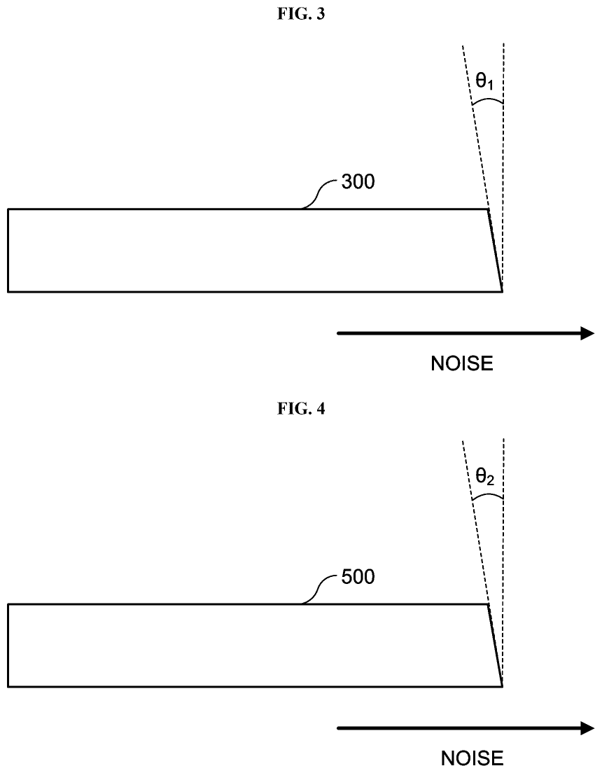

FIG. 3 is an enlarged schematic view illustrating the first angle-cleaved fiber 300 employed in the separation filter 1000 according to the first embodiment of the technique of the present disclosure.

As shown in FIG. 3, the second end of the first angle-cleaved fiber 300 may be angle-cut to form a first angle θ1 relative to the vertical direction.

In a case where the second end of the first angle-cleaved fiber 300 is cut in a vertical orientation (i.e., where the first angle θ1 equals 0°), noise may be reflected from the second end of the first angle-cleaved fiber 300 by Fresnel reflection. In such a case, the reflected noise is redirected through the first fiber Bragg grating 200 and is subsequently introduced into the second port of the optical circulator 100.

On the other hand, in the first embodiment, the second end of the first angle-cleaved fiber 300 is cut to form the first angle θ1 relative to the vertical direction, thereby minimizing the noise reflected by Fresnel reflection at the second end of the first angle-cleaved fiber 300. Accordingly, in the first embodiment, the reflection of noise by Fresnel reflection at the second end of the first angle-cleaved fiber 300 is minimized, thereby eliminating noise and allowing only the quantum signal to be output through the fourth port of the optical circulator 100.

In one embodiment, the first angle θ1 may be preferably within a range from 6° to 15° (that is, the first angle θ1 may be equal to or greater than 6° and less than or equal to 15°). In particular, when the first angle θ1 is set to 8°, maximum reflection loss may be achieved at the second end of the first angle-cleaved fiber 300. Therefore, it may be more preferable for the first angle θ1 to be 8°.

Conversely, in a case where the first angle θ1 is less than 6°, the reflection loss decreases gradually, resulting in an increased amount of noise being reflected from the second end of the first angle-cleaved fiber 300.

Further, in a case where the first angle θ1 exceeds 15°, the second end of the first angle-cleaved fiber 300 becomes sufficiently thin such that even minor impacts may cause damage to the second end of the first angle-cleaved fiber 300, thereby complicating the maintenance of the first angle-cleaved fiber 300.

Consequently, it is preferred that the first angle θ1 is set to be in the range from 6° to 15°.

In the first embodiment, the second fiber Bragg grating 400 may be connected to the third port of the optical circulator 100. The second fiber Bragg grating 400 may be configured to selectively reflect the wavelength component corresponding to the quantum signal from an input signal received though the second and third ports of the optical circulator 100, and to route the reflected wavelength component toward the third port of the optical circulator 100 for output.

Similarly to the first fiber Bragg grating 200, the second fiber Bragg grating 400 may be configured to reflect the quantum signal toward the third port of the optical circulator 100, while passing the noise through the second fiber Bragg grating 400 and transmitting the noise through the second angle-cleaved fiber 500.

The second angle-cleaved fiber 500 may include a first end and a second end. The first end may be connected to the second fiber Bragg grating 400, while the second end may be angle-cut to form a predetermined second angle.

FIG. 4 is an enlarged schematic view illustrating the second angle-cleaved fiber 500 employed in the separation filter 1000 according to the first embodiment of the technique of the present disclosure.

As shown in FIG. 4, the second end of the second angle-cleaved fiber 500 may be angle-cut (cleaved) to form a second angle θ2 relative to the vertical direction.

In one embodiment, the second angle θ2 may be preferably within a range from 6° to 15°, similar to the first angle θ1. In particular, when the second angle θ2 is set to 8°, maximum reflection loss may be achieved at the second end of the second angle-cleaved fiber 500. Therefore, it may be more preferable for the second angle to be 8°.

In one embodiment, the first angle θ1 and the second angle θ2 may be substantially identical. In another embodiment, the first angle θ1 and the second angle θ2 may be different from each other.

In one embodiment, at least one of the second end of the first angle-cleaved fiber 300 or the second end of the second angle-cleaved fiber 500 may be coated with a refractive index matching material. In a case where the refractive index matching material is applied, the effective first angle θ1 of the coated first angle-cleaved fiber 300 or the effective second angle θ2 of the coated second angle-cleaved fiber 500 may be 0°. In other words, irrespective of the specific values of the first angle θ1 or the second angle θ2, the application of the refractive index matching material may minimize the reflection of noise at the second end of the first angle-cleaved fiber 300 or at the second end of the second angle-cleaved fiber 500.

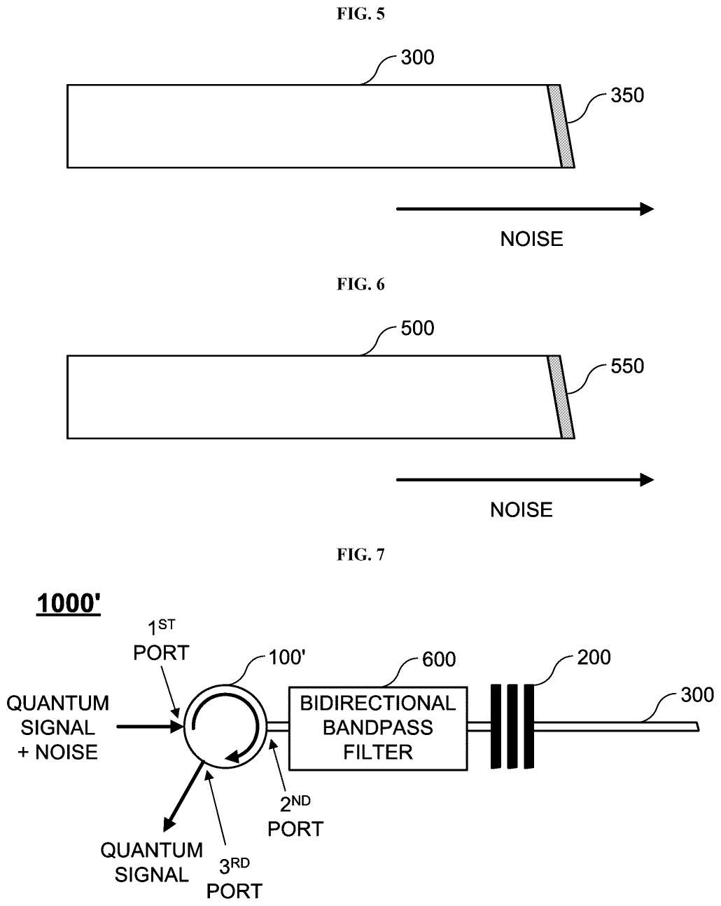

FIG. 5 is an enlarged schematic view illustrating a refractive index matching material 350 applied to the first angle-cleaved fiber 300 in the separation filter 1000 according to the first embodiment of the technique of the present disclosure.

In the first embodiment, the refractive index matching material 350 may be coated on the second end of the first angle-cleaved fiber 300. It is preferred that the refractive index of the refractive index matching material 350 is substantially identical to that of the first angle-cleaved fiber 300. For instance, it is preferred that the refractive index of the refractive index matching material 350 is maintained within a range from 1.4 to 1.5 (that is, the refractive index may be equal to or greater than 1.4 and less than or equal to 1.5).

The refractive index matching material 350 may include, for example, a refractive index matching liquid or a refractive index matching oil.

In a case where the refractive index matching material 350 is coated on the second end of the first angle-cleaved fiber 300, the reflection of noise at the second end of the first angle-cleaved fiber 300 may be minimized as the noise is dispersed through the refractive index matching material 350.

FIG. 6 is an enlarged view schematically illustrating a refractive index matching material 550 applied to the second angle-cleaved fiber 500 in the separation filter 1000 according to the first embodiment of the technique of the present disclosure.

In a manner similar to the refractive index matching material 350, it is preferred that the refractive index of the refractive index matching material 550 is maintained within a range from 1.4 to 1.5.

Further, the refractive index matching material 550 may include, for example, a refractive index matching liquid or a refractive index matching oil.

In the first embodiment of the separation filter 1000, for example, the quantum signal and the noise are introduced through the first port of the optical circulator 100. Subsequently, the noise is effectively eliminated by the first fiber Bragg grating 200 in combination with the first angle-cleaved fiber 300 and the second fiber Bragg grating 400 in combination with the second angle-cleaved fiber 500. As a result, the quantum signal is output through the fourth port of the optical circulator 100.

Specifically, even when residual noise remains in the signal output to the third port by the first fiber Bragg grating 200 and the first angle-cleaved fiber 300, the second fiber Bragg grating 400 and the second angle-cleaved fiber 500 further remove the noise more effectively. As a result, only the quantum signal is output through the fourth port of the optical circulator 100.

According to the first embodiment, the quantum signal and the amplified optical signal (particularly, the noise components associated with the amplified optical signal, spontaneous Raman scattering, and amplifier ASE) are efficiently separated, resulting in a reduction in the quantum bit error rate and an increase in the transmission distance of the quantum signal.

### Second Embodiment

FIG. 7 is a schematic view illustrating an exemplary configuration of a separation filter 1000′ according to a second embodiment of the technique of the present disclosure.

As shown in FIG. 7, the separation filter 1000′ according to the second embodiment may include, for example, an optical circulator 100′, a first fiber Bragg grating 200, a first angle-cleaved fiber 300, and a bidirectional bandpass filter 600.

Unlike the optical circulator 100 employed in the separation filter 1000 of the first embodiment, which includes four ports (i.e., the first port, the second port, the third port, and the fourth port), the optical circulator 100′ used in the separation filter 1000′ of the second embodiment may include a first port, a second port, and a third port. That is, the optical circulator 100′ may be a three-port optical circulator including the first port, the second port, and the third port.

In the optical circulator 100′ of the second embodiment, a signal entering via the first port may be output through the second port, while a signal entering via the second port may be output through the third port. Additionally, a signal entering via the third port may be output through the first port.

In the second embodiment, a quantum signal along with noise (specifically, the noise components generated by the amplification of the optical signal, the spontaneous Raman scattering, and the amplifier ASE) may be input to the first port and may be routed to the second port for output.

In the second embodiment, the bidirectional bandpass filter 600 may be connected to the second port of the optical circulator 100′. The bidirectional bandpass filter 600 may be configured to selectively pass through the wavelength component corresponding to the quantum signal from an input signal that includes the quantum signal and noise and is received through the first and second ports of the optical circulator 100′. In particular, the bidirectional bandpass filter 600 may pass the wavelength component corresponding to the quantum signal from the signal introduced through the second port of the optical circulator 100′ as well as from the signal reflected by the first fiber Bragg grating 200.

The first fiber Bragg grating 200 may be connected to the bidirectional bandpass filter 600. The first fiber Bragg grating 200 may be configured to selectively reflect the wavelength component corresponding to the quantum signal from the input signal provided through the bidirectional bandpass filter 600, and to route the reflected wavelength component (the quantum signal) toward the second port of the optical circulator 100′ through the bidirectional bandpass filter 600.

The first fiber Bragg grating 200 of the second embodiment is substantially identical to that of the first embodiment, except that the first fiber Bragg grating 200 of the second embodiment is connected to the bidirectional bandpass filter 600. Therefore, a detailed description thereof will be omitted.

The first angle-cleaved fiber 300 may include a first end and a second end. The first end is connected to the first fiber Bragg grating 200 and the second end is angle-cut (cleaved) to form a first angle.

The first angle-cleaved fiber 300 of the second embodiment is substantially identical to that of the first embodiment, and thus a detailed description thereof will be omitted.

According to the separation filter 1000′ of the second embodiment, for example, a quantum signal along with noise is input through the first port of the optical circulator 100′. Then, after the noise is eliminated by the bidirectional bandpass filter 600 in combination with the first fiber Bragg grating 200 and the first angle-cleaved fiber 300, the quantum signal is output through the third port of the optical circulator 100′.

Specifically, even when residual noise remains in the signal reflected to the bidirectional bandpass filter 600 by the first fiber Bragg grating 200 and the first angle-cleaved fiber 300, the bidirectional bandpass filter 600 further removes the noise more effectively, ensuring that only the quantum signal is output through the third port of the optical circulator 100′.

According to the second embodiment, the quantum signal and the amplified optical signal (particularly, the noise components generated by the amplification of the optical signal, the spontaneous Raman scattering, and the amplifier ASE) are efficiently separated, resulting in a reduction in the quantum bit error rate and an increase in the transmission distance of the quantum signal.

### Third Embodiment

The separation filter 1000 described in the first embodiment of the technique of the present disclosure or the separation filter 1000′ described in the second embodiment of the technique of the present disclosure may be employed in a quantum communication system.

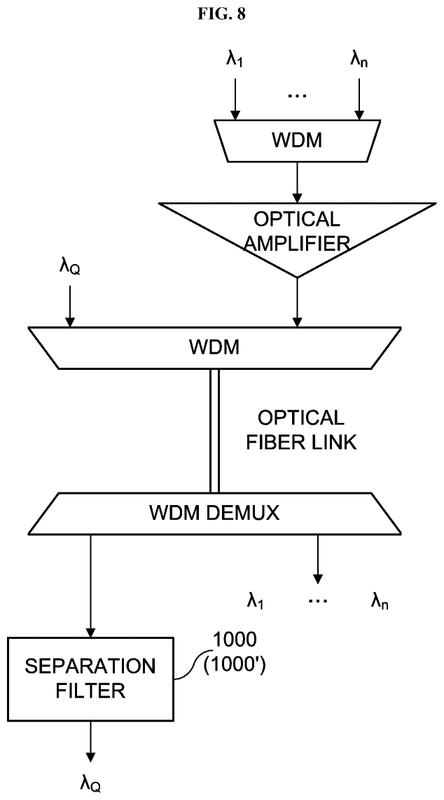

FIG. 8 is a schematic view illustrating an example in which the separation filter 1000 or the separation filter 1000′ according to the technique of the present disclosure is employed in the quantum communication system.

Referring to FIG. 8, at a transmitter of the quantum communication system, a plurality of optical signals λ₁ to λₙ are first multiplexed by a wavelength division multiplexer (WDM) and then amplified by an optical amplifier. The amplification of the optical signals by the optical amplifier may generate noise.

A quantum signal λ_{Q} is then multiplexed with the amplified optical signals using a wavelength-division multiplexer (WDM) and transmitted to a receiver of the quantum communication system through an optical fiber link.

At the receiver of the quantum communication system, a WDM demultiplexer (DEMUX) separates (demultiplex) the plurality of optical signals λ₁ to λₙ and the quantum signal λ_{Q}. However, even when the WDM DEMUX is used to separate the quantum signal λ_{Q} from the plurality of optical signals λ₁ to λₙ, noise may still be introduced into the quantum signal λ_{Q}.

According to the third embodiment, by utilizing the separation filter 1000 of the first embodiment or the separation filter 1000′ of the second embodiment, the quantum signal and the amplified optical signals (particularly, the noise components generated by the amplification of the optical signal, the spontaneous Raman scattering, and the amplifier ASE) can be efficiently separated, thereby reducing the quantum bit error rate and increasing the transmission distance of the quantum signal.

### Other Embodiments

While the technique of the present disclosure is described in detail by way of the embodiments described above, the technique of the present disclosure is not limited thereto and it will be apparent to those skilled in the art that the technique of the present disclosure may be modified in various ways without departing from the scope thereof.

Accordingly, the exemplary embodiments disclosed herein are not used to limit the technique of the present disclosure, but to explain the technique of the present disclosure, and the scope of the technique of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

According to some embodiments of the present disclosure, it is possible to efficiently separate the quantum signal from the amplified optical signals (particularly from the noise components generated by the amplification of the optical signal, the spontaneous Raman scattering, and the amplifier ASE), even when the quantum signal and the amplified optical signals are combined for transmission and reception using wavelength-division multiplexing (WDM) technology. As a result, the quantum bit error rate is reduced and the transmission distance of the quantum signal is extended.

What is claimed is:

1. A separation filter comprising:
an optical circulator including a first port, a second port, a third port, and a fourth port;
a first fiber Bragg grating connected to the second port and configured to: reflect a wavelength component of a signal input through the first and second ports and including both a quantum signal and noise wherein the wavelength component corresponds to the quantum signal; and output the reflected wavelength component toward the second port;
a first angle-cleaved fiber having a first end and a second end, the first end being connected to the first fiber Bragg grating and the second end being angle-cut to form a predetermined first angle;
a second fiber Bragg grating connected to the third port and configured to: reflect a wavelength component of a signal input through the second and third ports wherein the wavelength component corresponds to the quantum signal; and output the reflected wavelength component toward the third port; and
a second angle-cleaved fiber having a first end and a second end, the first end being connected to the second fiber Bragg grating and the second end being angle-cut to form a predetermined second angle,
wherein the quantum signal input through the third port is output through the fourth port.

2. The separation filter of claim 1, wherein the first angle and the second angle are substantially identical to each other.

3. The separation filter of claim 1, wherein each of the first angle and the second angle is in a range from 6° and 15°.

4. The separation filter of claim 1, wherein at least one of the second end of the first angle-cleaved fiber or the second end of the second angle-cleaved fiber is coated with a refractive index matching material.

5. The separation filter of claim 4, wherein a refractive index of the refractive index matching material is in a range from 1.4 and 1.5.

6. A separation filter comprising:
an optical circulator including a first port, a second port, and a third port;
a bidirectional bandpass filter connected to the second port of the optical circulator and configured to pass a wavelength component from a signal input through the first and second ports and including both a quantum signal and noise wherein the wavelength component corresponds to the quantum signal;
a first fiber Bragg grating connected to the bidirectional bandpass filter and configured to: reflect a wavelength component of a signal received through the bidirectional bandpass filter wherein the wavelength component corresponds to the quantum signal; and output the reflected wavelength component through the bidirectional bandpass filter and the second port; and
a first angle-cleaved fiber having a first end and a second end, the first end being connected to the first fiber Bragg grating and the second end being angle-cut to form a predetermined first angle,
wherein the quantum signal input through the second port is output through the third port.

7. The separation filter of claim 6, wherein the first angle is in a range from 6° and 15°.

8. The separation filter of claim 6, wherein the second end of the first angle-cleaved fiber is coated with a refractive index matching material.

9. The separation filter of claim 8. wherein a refractive index of the refractive index matching material is in a range from 1.4 and 1.5.

10. A quantum communication system comprising the separation filter according to claim 1.

11. A quantum communication system comprising the separation filter according to claim 6.
